(19) United States
(12) Patent Application Publication
(10) Pub. No.: US 2017/0153867 A1
(43) Pub. Date: Jun. 1, 2017

(54) WEB BROWSING METHOD AND DEVICE OF A BROWSER

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Kai Ren, Tianjin (CN); Shaopeng Yu, Tianjin (CN)

(21) Appl. No.: 15/247,644

(22) Filed: Aug. 25, 2016

Related U.S. Application Data
(63) Continuation of application No. PCT/CN2016/088888, filed on Jul. 6, 2016.

(30) Foreign Application Priority Data
Dec. 1, 2015 (CN) 201510870831.9

(51) Int. Cl. G06F 3/16; G06F 17/27; H04L 29/08

(52) U.S. Cl. CPC G06F 3/167; H04L 67/02; G06F 17/272

(57) ABSTRACT

An embodiment of the present disclosure discloses a web browsing method of a browser and a web browsing device of a browser. The method includes: receiving a browsing request from a server; acquiring web data corresponding to the browsing request; acquiring one or more web texts according to the web data; receiving at least one browsing instruction; controlling a browser to carry out voice reading operation of the one or more web texts according to the browsing instruction. According to the embodiment of the present disclosure, users not only may conveniently learn relevant content of a web page, but also may browse the web without dragging the web text upwards and downwards; at the same time, people with limited vision, such as the elderly, may browse the web, so that user experience is greatly improved.

### CROSS-REFERENCE TO RELATED APPLICATIONS

The present disclosure is a continuation of International Application No. PCT/CN2016/088888 filed on Jul. 6, 2016, which is based upon and claims priority to Chinese Patent Application No. 201510870831.9, entitled “WEB BROWSING METHOD OF BROWSER AND WEB BROWSING DEVICE OF BROWSER”, filed on Dec. 1, 2015, the entire contents of all of which are incorporated herein by reference.

### FIELD OF TECHNOLOGY

On one aspect, the present disclosure generally relates to the technical field of browsers, in particular to a web browsing method of a browser and a web browsing device of a browser.

### BACKGROUND

Voice technology becomes popular using in browser products at present time. The voice technology includes a voice input mode and a voice command mode. In the first mode, namely the voice input mode, there are products such as voice search and voice input text; in the voice command mode, the browser moves forwards or backwards via voice control. In the second mode, commands are executed via words converted from a voice, the second mode could be considered as a new interactive mode; but operations are executed when interacting are controlled via a voice, namely a new user interface (UI). Current browser products limit the use of the second mode: the second mode is a general control irrelevant to web content, so that the second mode must be universal, namely controlling operations capable of being carried out on various webs, such as paging, forwarding, backwarding, opening the webs. In other words, the second mode aims at functions of the browser itself, irrelevant to the specific web content.

As a result, in the voice command mode in prior art, only the general control irrelevant to the web content may be executed via the voice on a browser, but the specific content aiming at a web cannot be controlled, thus user experience is poor.

### SUMMARY

Some embodiments of the present disclosure disclose a web browsing method of a browser and a web browsing device of a browser. The method and the device are applicable to solving problems that specific content aiming at a web cannot be controlled and user experience is poor, achieving a function of carrying out voice reading operations of a web text according to browsing instructions sent by users, thereby improving the user experience.

To solve the problem above, an embodiment of the present disclosure discloses a web browsing method of a browser, comprising: receiving a browsing request from a server; acquiring web data corresponding to the browsing request; acquiring one or more web texts according to the web data; receiving at least one browsing instruction; and controlling a browser to carry out voice reading operations of the one or more web texts according to the browsing instruction.

To solve the problem above, an embodiment of the present disclosure discloses a computing device for web browsing, comprising at least one processor; and a memory communicably connected with the at least one processor for storing instructions executable by the at least one processor, wherein execution of the instructions by the at least one processor causes the at least one processor to: receive a browsing request from a server; acquire web data corresponding to the browsing request; acquire one or more web texts according to the web data; receive at least one browsing instruction; control a browser to carry out voice reading operation of the one or more web texts according to the browsing instruction.

According to an aspect, an embodiment of the present disclosure discloses a computer program comprises computer-readable codes; when the computer-readable codes run on computing devices, the computing devices carry out the web browsing method of the browser above.

According to another aspect, an embodiment of the present disclosure discloses a non-transitory computer-readable medium storing executable instructions that, when executed by a computing device, cause the computing device to: receive a browsing request from a server; acquire web data corresponding to the browsing request; acquire one or more web texts according to the web data; receive at least one browsing instruction; and control a browser to carry out voice reading operation of the one or more web texts according to the browsing instruction.

According to the web browsing method of the browser and the web browsing device of the browser disclosed in the embodiment of the present disclosure, the method includes: after receiving a browsing request from a server, acquiring web data corresponding to the browsing request, then acquiring one or more web texts according to the web data; after receiving at least one browsing instruction, controlling the browser to carry out a voice reading operation of the one or more web texts according to the browsing instruction. According to the embodiment of the present disclosure, users not only may conveniently learn relevant content of the web page, but also may browse the web without dragging the web text upwards and downwards; at the same time, people with limited vision may browse the web, so that user experience is greatly improved.

### BRIEF DESCRIPTION OF THE DRAWINGS

In order to more clearly illustrate the embodiments of the present disclosure or the technical schemes in prior art, drawings used in the embodiments or the prior art are simply introduced as follows. Obviously, the drawings in the description are some embodiments of the present disclosure, and a person skilled in the art may obtain other drawings without creative work according to those drawings.

FIG. 1 is a step flow chart of a web browsing method of a browser according to an embodiment of the present disclosure.

FIG. 2 is a step flow chart of another web browsing method of a browser according to an embodiment of the present disclosure.

FIG. 3 is a structure diagram of a web browsing device of a browser according to an embodiment of the present disclosure.

FIG. 4 is a structure diagram of another web browsing device of a browser according to an embodiment of the present disclosure.

FIG. 5 is a schematic diagram for carrying out a computing device according to steps of the method of the present disclosure.

FIG. 6 is a schematic diagram of a storage unit for maintaining or carrying a program code according to the method of the present disclosure.

### DESCRIPTION OF THE EMBODIMENTS

In order to clarify the objectives, technical schemes and advantages of the embodiments of the present disclosure, the technical schemes in the embodiments of the present disclosure are described clearly and integrally in a way that combines the drawings in the embodiments of the present disclosure. Obviously, the described embodiments are some embodiments of the present disclosure, rather than all embodiments. Based on the embodiments of the present disclosure, all of the other embodiments obtained by a person skilled in the art without creative work are within the protection scope of the present disclosure.

### Embodiment 1

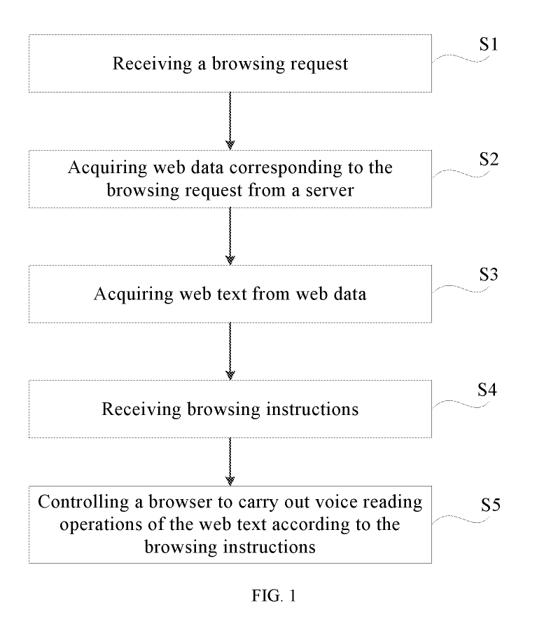

A step flow chart of a web browsing method of a browser according to Embodiment 1 is shown in FIG. 1.

The web browsing method, implemented by a computing device, includes the steps as follows.

S1: receiving a browsing request from a server.

Users may send the browsing request by entering words and voice or clicking tabs on a currently-opened web of the browser, wherein some websites may be opened via the browsing request in step S1. Specifically, according to the embodiment of the present disclosure, the browser may be the one in smart devices, such as televisions, computers, smart phones and the like. The users may be people with normal vision, or people with limited vision, such as the elderly, those with myopia or hyperopia, etc.

S2: acquiring web data corresponding to the browsing request.

The web in step S2 may be an article page, a news page and so on, wherein for the article page, the web data may be articles, links and the like on the current page; for the news page, the web data may be the articles, the links, pictures and the like on the current page.

S3: acquiring one or more web texts according to the web data.

In step S3, the one or more web texts may be the content of intensive words in the web data.

S4: receiving at least one browsing instruction.

The at least one browsing instruction may be the instructions for beginning to carry out voice reading operations, suspending to carry out the voice reading operations, continuing to carry out the voice reading operations or stopping to carry out the voice reading operations.

S5: controlling a browser to carry out voice reading operation of the one or more web texts according to the browsing instruction.

In step S5, the browser may be controlled to implement the instructions for beginning to carry out voice reading operations of the one or more web texts, suspending to carry out the voice reading operations of the web texts, continuing to carry out the voice reading operations of the web texts or stopping to carry out the voice reading operations of the web texts. It should be noted that when the browser is controlled to implement the instructions for beginning to carry out voice reading operations of the web texts and continuing to carry out the voice reading operations of the web texts, the browser reads the corresponding web texts, thus the users may conveniently learn the relevant content of the web page, without dragging the web text upwards and downwards, so that user experience is greatly improved.

For example, when the elderly clicks a news tab that Xi Jinping Comes to The UK on A State Visit on the currently-opened web of the browser, the browsing request received in step S1 is to open the web corresponding to the news tab, the web data corresponding to the browsing request may be obtained from the server in step S2, including the pictures during the state visit period and relevant reports of various pictures, the web text namely the relevant reports of various pictures may be obtained from the web data in step 3, thus after the browsing instructions for beginning to carry out the voice reading operations sent by the elderly are received, the browser is controlled to carry out the voice reading operations of the web text in step S5, then the browser reads the corresponding web text, so that the elderly may conveniently learn content of the web page.

According to the embodiment 1 of the present disclosure, after the browsing request such of opening some website is received, the web data such as the articles, the links and the like corresponding to the browsing request may be obtained from the server, thus the web text such as the content of intensive words in the web data may be obtained from the web data, and after the browsing instructions such of beginning to carry out the voice reading operations of the web text are received, the browser is controlled to carry out the voice reading operations of the web text according to the browsing instructions, such that the browser is controlled to carry out the voice reading operations of the web text, and then the browser reads the corresponding web text. According to the embodiment of the present disclosure, users not only may conveniently learn relevant content of a web page, but also may browse the web without dragging the web text upwards and downwards; at the same time, people with limited vision, such as the elderly, may browse the web, so that user experience is greatly improved.

### Embodiment 2

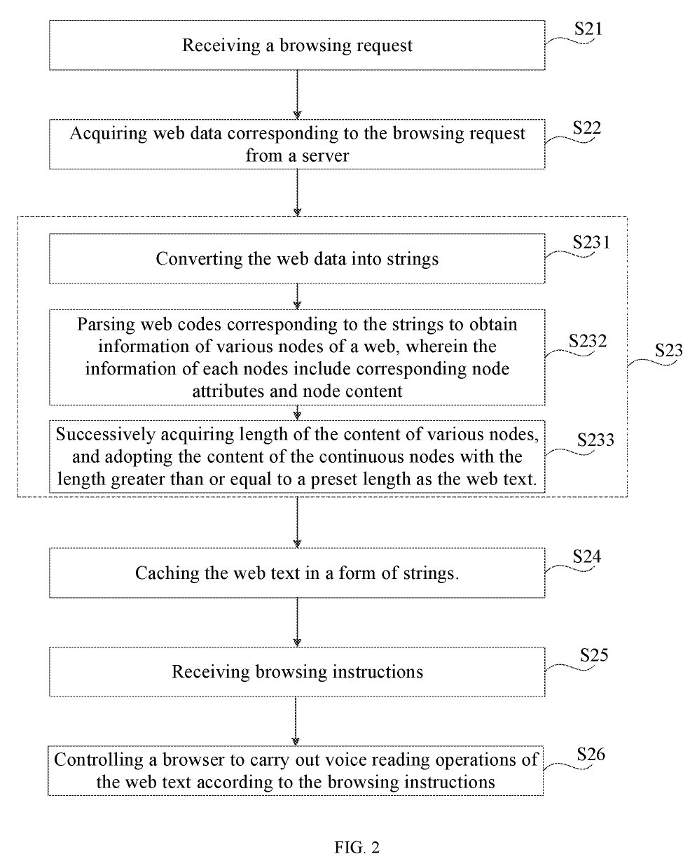

A step flow chart of another web browsing method of a browser according to Embodiment 2 of the present disclosure is shown in FIG. 2. The web browsing method of the browser includes steps as follows.

S21: receiving a browsing request from a server.

Users may send the browsing request by entering words and voice or clicking tabs on a currently-opened web of the browser, wherein some website may be opened via the browsing request in step S21. Specifically, according to the embodiment of the present disclosure, the browser may be the one in smart devices, such as televisions, computers, smart phones and the like. The users may be people with normal vision, or people with limited vision, such as the elderly, those with myopia or hyperopia, etc.

S22: acquiring web data corresponding to the browsing request.

The web in step S22 may be an article page, a news page and so on, wherein for the article page, the web data may be articles, links and the like on the current page; for the news page, the web data may be the articles, the links, pictures and the like on the current page.

S23: the step of acquiring web text from web data includes:

S231: converting at least one part of the web data into one or more strings;

S232: parsing one or more web codes corresponding to the one or more strings to obtain information of various nodes of a web, wherein the information of each of nodes include corresponding node attributes and node content;

S233: successively acquiring content length of each node, and adopting the one or more continuous nodes with the content length greater than or equal to a preset length as the web text.

In step S233, the one or more continuous nodes with the content length greater than or equal to the preset length is the content of the intensive words in the web data. According to an embodiment of the present disclosure, the continuous nodes contain three or more nodes, and the preset length is 160 characters, namely the length of each of three or more nodes is greater than or equal to 160 characters, and the content of the three or more nodes is adopted as the web text.

S24: caching the web text in a form of strings.

S25: receiving at least one browsing instruction.

Specifically, the browsing instructions may be the instructions for beginning to carry out voice reading operations, suspending to carry out the voice reading operations, continuing to carry out the voice reading operations or stopping to carry out the voice reading operations.

According to an embodiment of the present disclosure, the browsing instructions in step S25 may be voice browsing instructions sent by the users; at the moment, the voice browsing instructions may be recognized via a voice recognition chip in step S25. Specifically, when the browsing instructions are the voice browsing instructions sent by the users, the step S25 includes:

receiving a trigger signal generated when pressing a voice recognition button, wherein the voice recognition button is arranged on the front end of the current web shown on the browser;

receiving the voice browsing instructions when the duration of triggering signal is greater than or equal to the preset time.

The voice browsing instructions sent by the users may be received via a microphone or a headset, language received in step S25 may be Chinese, English and the like. In actual applications, the language received in step S25 may be set in advance or set according to the languages mastered by the users. In addition, when the duration of triggering signal is less than the preset time, for example, when the users falsely press the voice recognition button, they may control the microphone or the headset not to receive the voice browsing instructions. Specifically, in applications, the preset time may be set in advance according to the actual situations or set by the users according to their own personal habits.

According to another embodiment of the present disclosure, the browsing instructions in step S25 may be generated by triggering any button in a browsing way selection list. The browsing way selection list may be set on the front end of the current web interface for the users to conveniently select. The browsing way selection list includes a selection button of beginning to carry out voice reading operations, a selection button of suspending to carry out the voice reading operations, a selection button of continuing to carry out the voice reading operations or a selection button of stopping to carry out the voice reading operations. Correspondingly, when the users trigger the selection button of beginning to carry out voice reading operations, the instructions for beginning to carry out voice reading operations are received in step S25; when the users trigger the selection button of suspending to carry out the voice reading operations, the instructions for suspending to carry out the voice reading operations are received in step S25; when the users trigger the selection button of continuing to carry out the voice reading operations, the instructions for continuing to carry out the voice reading operations are received in step S25; when the users trigger the selection button of stopping to carry out the voice reading operations, the instructions for stopping to carry out the voice reading operations are received in step S25.

S26: controlling a browser to carry out a voice reading operation of the one or more web texts according to the browsing instruction.

Specifically, in step S26, when the browsing instruction is the instruction for beginning to carry out voice reading operation, the browser may be controlled to carry out the voice reading operations from the initial position of the web text; at the moment, the browser begins to read from the initial position of the text of the current web until to the end of the text of the current web or until to receive the instructions for suspending to carry out the voice reading operations or the instructions for stopping to carry out the voice reading operations; wherein the initial position of the web text is the position of the first string cached in step S24, the end of the web text is the position of the last string cached in step S24.

When the browsing instructions are the instructions for suspending to carry out the voice reading operations, the browser may be controlled to suspend the voice reading operations of the text of the current web, and record a suspend location of the web text; at the moment, the browser suspends to read.

When the browsing instructions are the instructions for continuing to carry out the voice reading operations, the browser may be controlled to carry out the voice reading operations from the suspend position of the text of the current web; at the moment, the browser reads from the suspend position of the web text until to the end of the web text or until to receive the instructions for suspending to carry out the voice reading operations or the instructions for stopping to carry out the voice reading operations.

When the browsing instructions are the instructions for stopping to carry out the voice reading operations, the browser may be controlled to stop the voice reading operations of the text of the current web; at the moment, the browser stops to read. Furthermore, after the browser is controlled to stop the voice reading operations of the web text, if the instructions for continuing to carry out the voice reading operations are received, the browser may be controlled to carry out the voice reading operations from the initial position of the web text; at the moment, the browser reads from the initial position of the web text until to the end of the web text or until to receive the instructions for suspending to carry out the voice reading operations or the instructions for stopping to carry out the voice reading operations.

Thus, the users may conveniently learn the relevant content of the web page without reading the words on the web and dragging the web text upwards or downwards, thereby improving the user experience.

It should be noted that when the browser reads the web text, if the users close or quit the browser, or the users drag the browser forwards or backwards, or the users open other link pages or subpages, the browser may be controlled to suspend the voice reading operations of the text of the current web, and record the suspend position of the web text; or the browser may be controlled to stop the voice reading operations of the text of the current web.

According to the embodiment 2 of the present disclosure, after the browsing request such of opening some website is received, the web data such as the articles, the links and the like corresponding to the browsing request may be obtained from a server, then the web data may be converted into the strings, and the page codes corresponding to the strings may be parsed to obtain the information of various nodes of the web (including the corresponding node attributes and node content), the content length of each node may be successively obtained, the one or more continuous nodes with the content length greater than or equal to the preset length is adopted as the web text; at the same time, the web text may be cached in a form of strings; after the browsing instructions such of beginning to carry out the voice reading operations of the text are received, the browser may be controlled to carry out the voice reading operations according to the browsing instructions, such that the browser is controlled to carry out the voice reading operations of the web text, and then the browser reads the corresponding web text. According to the embodiment of the present disclosure, users not only may conveniently learn relevant content of a web page, but also may browse the web without dragging the web text upwards and downwards; at the same time, people with limited vision, such as the elderly, may browse the web, so that user experience is greatly improved.

### Embodiment 3

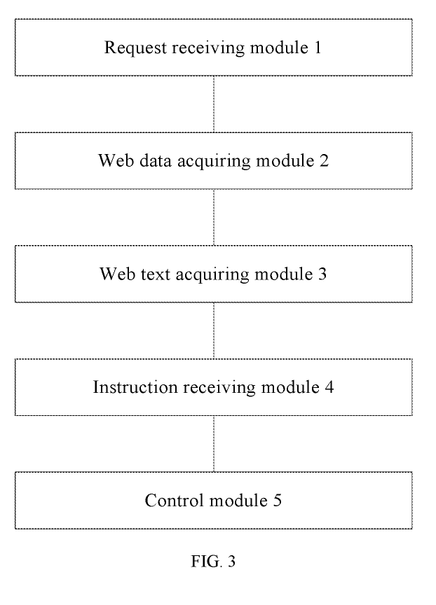

A structure diagram of a web browsing device of a browser according to Embodiment 3 of the present disclosure is shown in FIG. 3.

The web browsing device of the browser disclosed in the embodiment of the present disclosure includes:

a request receiving module 1, used for receiving a browsing request from a server.

Users may send the browsing request by entering words and voice or clicking tabs on a currently-opened web of the browser, wherein some website may be opened via the browsing request in the request receiving module 1. Specifically, according to the embodiment of the present disclosure, the browser may be the one in smart devices, such as televisions, computers, smart phones and the like. The users may be people with normal vision, or people with limited vision, such as the elderly, those with myopia or hyperopia, etc.

A web data acquiring module 2, used for acquiring web data corresponding to the browsing request.

The web in the web data acquiring module 2 may be an article page, a news page and so on, wherein for the article page, the web data may be articles, links and the like on the current page; for the news page, the web data may be the articles, the links, pictures and the like on the current page.

A web text acquiring module 3, used for acquiring one or more web texts according to web data.

In the web text acquiring module 3, the web text may be the content of intensive words in the web data.

An instruction receiving module 4, used for receiving at least one browsing instruction.

The browsing instructions may be the instructions for beginning to carry out voice reading operations, suspending to carry out the voice reading operations, continuing to carry out the voice reading operations or stopping to carry out the voice reading operations.

A control module 5, used for controlling a browser to carry out a voice reading operation of the one or more web texts according to the browsing instruction.

The control module 5 may control the browser to implement the instructions for beginning to carry out voice reading operations of the web text, suspending to carry out the voice reading operations of the web text, continuing to carry out the voice reading operations of the web text or stopping to carry out the voice reading operations of the web text. It should be noted that when the browser is controlled to implement the instructions for beginning to carry out voice reading operations of the web text and continuing to carry out the voice reading operations of the web text, the browser reads the corresponding web text, thus the users may conveniently learn the relevant content of the web page, without dragging the web text upwards and downwards, so that user experience is greatly improved.

For example, when the elderly clicks a news tab that Xi Jinping Comes to The UK on A State Visit on the currently-opened web of the browser, the browsing request received by the request receiving module 1 is to open the web corresponding to the news tab, the web data acquiring module 2 acquires the web data corresponding to the browsing request from the server, including the pictures during the state visit period and relevant reports of various pictures, the web text acquiring module 3 acquires the web text namely the relevant reports of various pictures from the web data, after instruction receiving module 4 receives the browsing instructions for beginning to carry out the voice reading operations sent by the elderly, the control module 5 controls the browser to carry out the voice reading operations of the web text, then the browser reads the corresponding web text, so that the elderly may conveniently learn the content of the web page.

According to the embodiment 3 of the present disclosure, after the request receiving module receives the browsing request such of opening some website, the web data acquiring module acquires the web data such as the articles, the links and the like corresponding to the browsing request from the server, then the web text acquiring module acquires the web text such as the content of the intensive words in the web data from the web data, and after the instruction receiving module receives the browsing instructions such of beginning to carry out the voice reading operations of the web text, the control module controls the browser to carry out the voice reading operations of the web text according to the browsing instructions, such that the control module controls the browser to carry out the voice reading operations of the web text, and then the browser reads the corresponding web text. According to the embodiment of the present disclosure, users not only may conveniently learn relevant content of the web page, but also may browse the web without dragging the web text upwards and downwards; at the same time, people with limited vision, such as the elderly, may browse the web, so that user experience is greatly improved.

### Embodiment 4

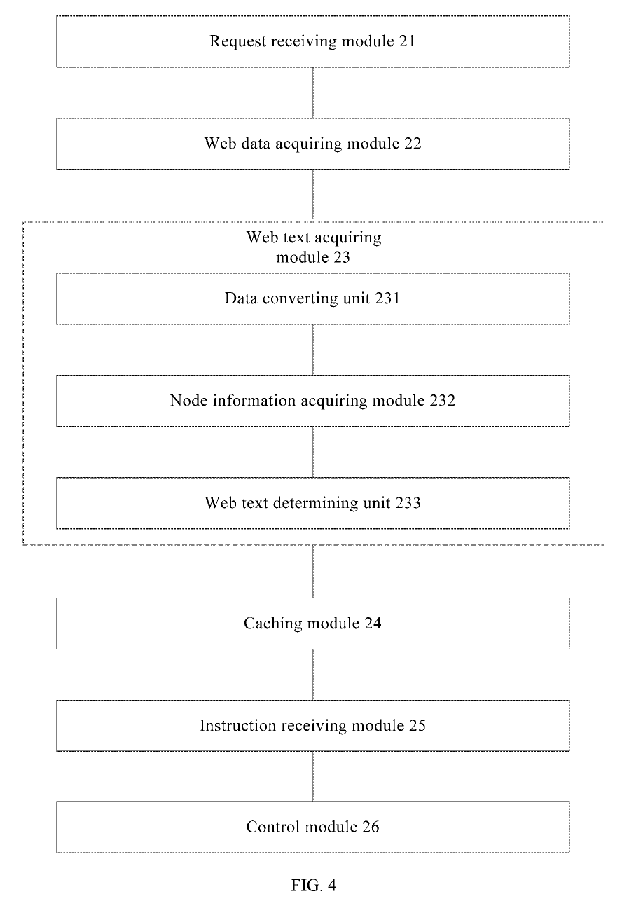

A structure diagram of another web browsing device of a browser according to Embodiment 4 of the present disclosure is shown in FIG. 4. The web browsing device of the browser includes:

a request receiving module 21, used for receiving a browsing request from a server.

Users may send the browsing request by entering words and voice or clicking tabs on a currently-opened web of the browser, wherein some website may be opened via the browsing request in the request receiving module 21. Specifically, according to the embodiment of the present disclosure, the browser may be the one in smart devices, such as televisions, computers, smart phones and the like. The users may be people with normal vision, or people with limited vision, such as the elderly, those with myopia or hyperopia, etc.

A web data acquiring module 22, used for acquiring web data corresponding to the browsing request.

The web in the web data acquiring module 22 may be an article page, a news page and so on, wherein for the article page, the web data may be articles, links and the like on the current page; for the news page, the web data may be the articles, the links, pictures and the like on the current page.

A web text acquiring module 23, used for acquiring one or more web texts according to web data, includes:

a data converting module 231, used for converting at least one part of the web data into one or more strings;

a node information acquiring module 232, used for parsing one or more web codes corresponding to the one or more strings to obtain information of various nodes of a web, wherein the information of each of nodes include corresponding node attributes and node content;

a web text determining module 233, used for successively acquiring content length of each node, and adopting the one or more continuous nodes with the content length greater than or equal to a preset length as the web text.

In the web text determining module 233, the one or more continuous nodes with the content length greater than or equal to the preset length is the content of the intensive words in the web data. According to an embodiment of the present disclosure, the continuous nodes contain three or more nodes, and the preset length is 160 characters, namely the length of each of three or more nodes is greater than or equal to 160 characters, and the content of the three or more nodes is adopted as the web text.

A caching module 24, used for caching the web text in a form of strings after the web text determining module 233 adopts one or more the continuous nodes with the content length greater than or equal to the preset length as the web text;

An instruction receiving module 25, used for receiving a browsing instruction from a server.

Specifically, the at least one browsing instruction may be the instructions for beginning to carry out voice reading operations, suspending to carry out the voice reading operations, continuing to carry out the voice reading operations or stopping to carry out the voice reading operations.

According to an embodiment of the present disclosure, the browsing instructions in the instruction receiving module 25 may be voice browsing instructions sent by the users; at the moment, the instruction receiving module 25 may recognize the voice browsing instructions via a voice recognition chip. Specifically, when the browsing instructions are the voice browsing instructions sent by the users, the instruction receiving module 25 includes:

a trigger signal receiving module, used for receiving a trigger signal generated when pressing a voice recognition button, wherein the voice recognition button is arranged on the front end of the current web shown on the browser;

an instruction receiving module, used for receiving the browsing instructions when the duration of triggering signal is greater than or equal to the preset time.

The instruction receiving module may receive the voice browsing instructions sent by the users via a microphone or a headset. The language received by the instruction receiving module 25 may be Chinese, English and the like. In actual applications, the language received by the instruction receiving module 25 may be set in advance or set according to the languages mastered by the users. In addition, when the duration of triggering signal is less than the preset time, for example, when the user falsely presses the voice recognition button, they may control the microphone or the headset not to receive the voice browsing instructions. Specifically, in applications, the preset time may be set in advance according to the actual situations or set by the users according to their own personal habits.

According to another embodiment of the present disclosure, the browsing instructions in the instruction receiving module 25 may be generated by triggering any button in a browsing way selection list. The browsing way selection list may be set on the front end of the current web interface for the users to conveniently select. The browsing way selection list includes a selection button of beginning to carry out voice reading operations, a selection button of suspending to carry out the voice reading operations, a selection button of continuing to carry out the voice reading operations or a selection button of stopping to carry out the voice reading operations. Correspondingly, when the users trigger the selection button of beginning to carry out voice reading operations, the instruction receiving module 25 receives the instructions for beginning to carry out voice reading operations; when the users trigger the selection button of suspending to carry out the voice reading operations, the instruction receiving module 25 receives the instructions for suspending to carry out the voice reading operations; when the users trigger the selection button of continuing to carry out the voice reading operations, the instruction receiving module 25 receives the instructions for continuing to carry out the voice reading operations; when the users trigger the selection button of stopping to carry out the voice reading operations, the instruction receiving module 25 receives the instructions for stopping to carry out the voice reading operations.

A control module 26, used for controlling a browser to carry out voice reading operations of the one or more web texts according to the browsing instructions.

Specifically, in the control module 26, when the browsing instructions are the instructions for beginning to carry out voice reading operations, the control module 26 controls the browser to carry out the voice reading operations from the initial position of the web text; at the moment, the browser begins to read from the initial position of the text of the current web until to the end of the text of the current web or until to receive the instructions for suspending to carry out the voice reading operations or the instructions for stopping to carry out the voice reading operations; wherein the initial position of the web text is the position of the first string cached in the caching module 24, the end of the web text is the position of the last string cached in the caching module 24.

When the browsing instructions are the instructions for suspending to carry out the voice reading operations, the control module 26 controls the browser to suspend the voice reading operations of the text of the current web, and record a suspend location of the web text; at the moment, the browser suspends to read.

When the browsing instructions are the instructions for continuing to carry out the voice reading operations, the control module 26 controls the browser to carry out the voice reading operations from the suspend position of the text of the current web; at the moment, the browser reads from the suspend position of the web text until to the end of the web text or until to receive the instructions for suspending to carry out the voice reading operations or the instructions for stopping to carry out the voice reading operations.

When the browsing instructions are the instructions for stopping to carry out the voice reading operations, the control module 26 controls the browser to stop the voice reading operations of the text of the current web; at the moment, the browser stops to read. Furthermore, after the control module 26 controls the browser to stop the voice reading operations of the web text, if the instruction receiving module 25 receives the instructions for continuing to carry out the voice reading operations, the control module 26 may control the browser to carry out the voice reading operations from the initial position of the web text; at the moment, the browser reads from the initial position of the web text until to the end of the web text or until to receive the instructions for suspending to carry out the voice reading operations or the instructions for stopping to carry out the voice reading operations.

Thus, the users may conveniently learn the relevant content of the web page without reading the words on the web and dragging the web text upwards or downwards, thereby improving the user experience.

It should be noted that when the browser reads the web text, if the users close or quit the browser, or the users drag the browser forwards or backwards, or the users open other link pages or subpages, the control module 26 may control the browser to suspend the voice reading operations of the text of the current web, and record the suspend position of the web text, or control the browser to stop the voice reading operations of the text of the current web.

According to the embodiment 4 of the present disclosure, after the request receiving module receives the browsing request such of opening some website, the web data acquiring module acquires the web data from a server, such as articles, links and the like corresponding to the browsing request, then the data converting module converts at least one part of the web data into one or more strings, the node information acquiring module parses the one or more web codes corresponding to one or more strings to obtain the information of various nodes of the web (including the corresponding node attributes and node content), the web text determining module successively acquires the content length of each node, and adopts one or more the continuous nodes with the content length greater than or equal to the preset length as the web text; at the same time, the caching module caches the web text in a form of strings; after the instruction receiving module receives the browsing instructions such of beginning to carry out the voice reading operations of the text, the control module controls the browser to carry out the voice reading operations according to the browsing instructions, such that the control module controls the browser to carry out the voice reading operations of the web text, and then the browser reads the corresponding web text. According to the embodiment of the present disclosure, users not only may conveniently learn relevant content of the web page, but also may browse the web without dragging the web text upwards and downwards; at the same time, people with limited vision, such as the elderly, may browse the web, so that user experience is greatly improved.

The device embodiments described above are schematic only, wherein units described as separate components may be or cannot be separated physically; components which are adopted as display units display may be or cannot be physical units, namely located on a place or distributed to a plurality of network units. The purpose of the schemes in the embodiment may be achieved via partial or all modules according to actual requirements. A person skilled in the art may understand and implement without creative labor.

Each of devices according to the embodiments of the disclosure may be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

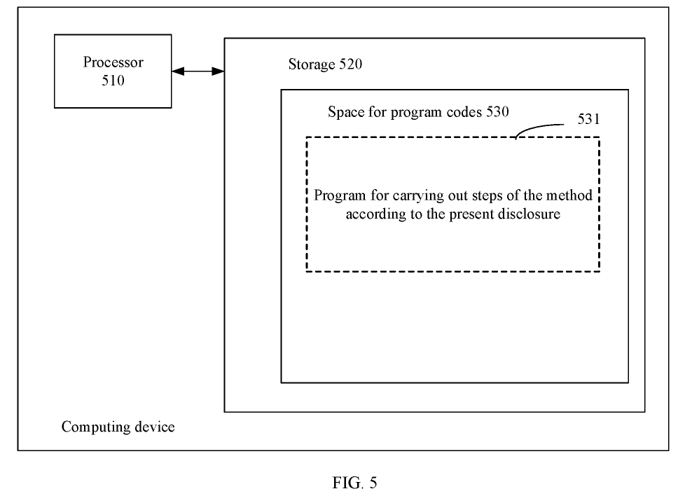

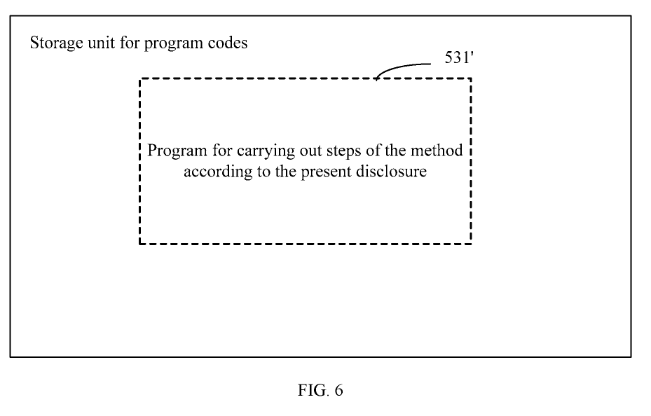

For example, FIG. 5 illustrates a block diagram of a computing device for executing the method according the disclosure. Traditionally, the computing device includes a processor 510 and a computer program product or a computer readable medium in form of a memory 520. The memory 520 could be electronic memories such as flash memory, EEPROM (Electrically Erasable Programmable Read-Only Memory), EPROM, hard disk or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 6. The memory cells may be provided with memory sections, memory spaces, etc., similar to the memory 520 of the computing device as shown in FIG. 5. The program codes may be compressed for example in an appropriate form. Usually, the memory cell includes computer readable codes 531′ which may be read for example by processors 510. When these codes are operated on the computing device, the computing device may execute respective steps in the method as described above.

Through the description of the above embodiments, a person skilled in the art may clearly know that the embodiments may be implemented by software and necessary universal hardware platforms, or by hardware. Based on this understanding, the above solutions or contributions thereof to the prior art may be reflected in form of software products, and the computer software products may be stored in computer readable media, for example, ROM/RAM, magnetic discs, optical discs, etc., including various commands, which are used for driving a computer device (which may be a personal computer, a server or a network device) to execute methods described in all embodiments or in some parts of the embodiments.

Finally, it should be noted that the above embodiments are merely used to describe instead of limiting the technical solution of the present disclosure; although the above embodiments describe the present disclosure in detail, a person skilled in the art shall understand that they may modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A web browsing method of a browser, implemented by a computing device, comprising:
receiving a browsing request from a server;
acquiring web data corresponding to the browsing request;
acquiring one or more web texts according to the web data;
receiving at least one browsing instruction;
controlling a browser to carry out a voice reading operation of the one or more web texts according to the browsing instruction.

2. The web browsing method according to claim 1, wherein acquiring one or more web texts according to the web data comprises:
converting at least one part of the web data into one or more strings;
parsing one or more web codes corresponding to the one or more strings to obtain information of each node of a web, wherein the information of each node comprises corresponding node attribute and node content;
successively acquiring the content length of each node, and adopting the one or more continuous nodes with the content length greater than or equal to a preset length as the web text.

3. The web browsing method according to claim 2, wherein after adopting the one or more continuous nodes with the content length greater than or equal to a preset length as the web text, the method further comprises:
caching the web text in a form of strings.

4. The web browsing method according to claim 1, wherein the browsing instruction is at least one instruction for beginning to carry out voice reading operation, suspending to carry out the voice reading operation, continuing to carry out the voice reading operation or stopping to carry out the voice reading operation.

5. The web browsing method according to claim 4, wherein:
if the browsing instruction is the instruction for beginning to carry out the voice reading instruction, controlling the browser to carry out the voice reading operation from an initial position of the web text until to the end of the web text or until to receive the instruction for suspending to carry out the voice reading operation or the instruction for stopping to carry out the voice reading operation;
if the browsing instruction is the instruction for suspending to carry out the voice reading operation, controlling the browser to suspend the voice reading operation of the web text and record a suspend location of the web text;
if the browsing instruction is the instruction for continuing to carry out the voice reading operation, controlling the browser to carry out the voice reading operation from the suspend location of the web text;
if the browsing instruction is the instruction for stopping to carry out the voice reading operation, controlling the browser to stop the voice reading operation of the web text.

6. The web browsing method according to claim 5, wherein after the step of controlling the browser to stop the voice reading operation of the web text, controlling the browser to carry out the voice reading operation from the initial position of the web text if receiving the instruction for continuing to carry out the voice reading operation.

7. A computing device for web browsing, comprising:
at least one processor; and
a memory communicably connected with the at least one processor for storing instructions executable by the at least one processor, wherein execution of the instructions by the at least one processor causes the at least one processor to:
receive a browsing request from a server;
acquire web data corresponding to the browsing request;
acquire one or more web texts according to the web data;
receive at least one browsing instruction;
control a browser to carry out voice reading operation of the one or more web texts according to the browsing instruction.

8. The computing device according to claim 7, wherein acquire one or more web texts according to the web data comprises:
converting at least one part of the web data into one or more strings;
parsing one or more web codes corresponding to the one or more strings to obtain information of each node of a web, wherein the information of each node comprises corresponding node attribute and node content;
successively acquiring the content length of each node, and adopting the one or more continuous nodes with the content length greater than or equal to a preset length as the web text.

9. The computing device according to claim 8, wherein execution of the instructions by the at least one processor causes the at least one processor to further:
cache the web text in a form of strings after adopting the one or more continuous nodes with the content length greater than or equal to a preset length as the web text.

10. The computing device according to claim 7, wherein the browsing instruction is at least one instruction for beginning to carry out the voice reading operation, suspending to carry out the voice reading operation, continuing to carry out the voice reading operation or stopping to carry out the voice reading operation.

11. The computing device according to claim 10, wherein execution of the instructions by the at least one processor causes the at least one processor to further:
if the browsing instruction is the instruction for beginning to carry out the voice reading instruction, control the browser to carry out the voice reading operation from an initial position of the web text until to the end of the web text or until to receive the instruction for suspending to carry out the voice reading operation or the instruction for stopping to carry out the voice reading operation;
if the browsing instruction is the instruction for suspending to carry out the voice reading operation, control the browser to suspend the voice reading operation of the web text and record a suspend location of the web text;
if the browsing instruction is the instruction for continuing to carry out the voice reading operation, control the browser to carry out the voice reading operation from the suspend location of the web text;
if the browsing instruction is the instruction for stopping to carry out the voice reading operation, control the browser to stop the voice reading operation of the web text.

12. The computing device according to claim 11, wherein after control the browser to stop the voice reading operation of the web text, execution of the instructions by the at least one processor causes the at least one processor to further control the browser to carry out the voice reading operation from the initial position of the web text if receiving the instruction for continuing to carry out the voice reading operation.

13. A non-transitory computer-readable medium storing executable instructions that, when executed by a computing device, cause the computing device to:
receive a browsing request from a server;
acquire web data corresponding to the browsing request;
acquire one or more web texts according to the web data;
receive at least one browsing instruction;
control a browser to carry out voice reading operation of the one or more web texts according to the browsing instruction.

14. The non-transitory computer-readable medium according to claim 13, wherein acquire one or more web texts according to the web data comprises:
converting at least one part of the web data into one or more strings;
parsing one or more web codes corresponding to the one or more strings to obtain information of each node of a web, wherein the information of each node comprises corresponding node attribute and node content;
successively acquiring the content length of each node, and adopt the one or more continuous nodes with the content length greater than or equal to a preset length as the web text.

15. The non-transitory computer-readable medium according to claim 14, wherein the computing device is further caused to:
cache the web text in a form of strings after adopting the one or more continuous nodes with the content length greater than or equal to a preset length as the web text.

16. The non-transitory computer-readable medium according to claim 13, wherein the browsing instruction is at least one instruction for beginning to carry out the voice reading operation, suspending to carry out the voice reading operation, continuing to carry out the voice reading operation or stopping to carry out the voice reading operation.

17. The non-transitory computer-readable medium according to claim 16, wherein the computing device is further caused to:
if the browsing instruction is the instruction for beginning to carry out the voice reading instruction, control the browser to carry out the voice reading operation from an initial position of the web text until to the end of the web text or until to receive the instruction for suspending to carry out the voice reading operation or the instruction for stopping to carry out the voice reading operation;
if the browsing instruction is the instruction for suspending to carry out the voice reading operation, control the browser to suspend the voice reading operation of the web text and record a suspend location of the web text;
if the browsing instruction is the instruction for continuing to carry out the voice reading operation, control the browser to carry out the voice reading operation from the suspend location of the web text;
if the browsing instruction is the instruction for stopping to carry out the voice reading operation, control the browser to stop the voice reading operation of the web text.

18. The non-transitory computer-readable medium according to claim 17, wherein after control the browser to stop the voice reading operation of the web text, the computing device is further caused to: control the browser to carry out the voice reading operation from the initial position of the web text if receiving the instruction for continuing to carry out the voice reading operation.
